(19) United States
(12) Patent Application Publication
(10) Pub. No.: US 2025/0117677 A1
(43) Pub. Date: Apr. 10, 2025

(54) APPLICATION ROBUSTNESS FOR FAULT-TOLERANT QUANTUM COMPUTERS

(71) Applicant: Zapata Computing, Inc., Boston, MA (US)

(72) Inventors: Rutuja Milind Kshirsagar, Revere, MA (US); Amara Katabarwa, Cambridge, MA (US); Peter Douglas Johnson, Portland, ME (US)

(21) Appl. No.: 18/476,968

(22) Filed: Sep. 28, 2023

Related U.S. Application Data
(60) Provisional application No. 63/410,922, filed on Sep. 28, 2022.

(51) Int. Cl. G06N 10/20; G06N 10/70

(52) U.S. Cl. CPC G06N 10/20; G06N 10/70

(57) ABSTRACT

Methods and systems perform conversion of time signals to frequency spectra. Such methods and systems facilitate a simple analysis of robustness under various algorithmic noise models. While a robustness analysis can be carried out for other methods of quantum phase estimation, the methods and systems provide a foundation for the robustness analysis beyond quantum phase estimation.

### BACKGROUND

Quantum computers promise to solve industry-critical problems which are otherwise unsolvable or only very inefficiently addressable using classical computers. Key application areas include chemistry and materials, bioscience and bioinformatics, logistics, and finance. Interest in quantum computing has recently surged, in part due to a wave of advances in the performance of ready-to-use quantum computers.

The expectation of the quantum computing field is that quantum architectures can scale up and realize fault-tolerant quantum computing. Due to engineering challenges, such “cheap” error correction may be decades away. Costly error correction might warrant settling for error-prone quantum computations. This has motivated the development of quantum algorithms which are robust to some degree of error as well as methods to analyze their performance in the presence of error. Several such algorithms have recently been developed; what is missing is a methodology to analyze their robustness.

### BRIEF DESCRIPTION OF THE FIGURES

FIG. 1 is a diagram of a quantum computer according to one embodiment of the present invention;

FIG. 2A is a flowchart of a method performed by the quantum computer of FIG. 1 according to one embodiment of the present invention;

FIG. 2B is a diagram of a hybrid quantum-classical computer which performs quantum annealing according to one embodiment of the present invention; and

FIG. 3 is a diagram of a hybrid quantum-classical computer according to one embodiment of the present invention.

FIG. 4 is a flowchart of a method performed by one embodiment of the present invention.

FIG. 5 is a quantum circuit diagram of a Hadamard test.

FIG. 6 is a pseudocode description of one embodiment of the present invention.

### DETAILED DESCRIPTION

Embodiments of the present invention include methods and systems for performing conversion of time signals to frequency spectra, an important process in phase estimation. A feature of at least some embodiments is their facilitation of a simple analysis of its robustness under various algorithmic noise models. While a robustness analysis can be carried out for other methods of quantum phase estimation, embodiments of the present invention provide a foundation for the robustness analysis beyond quantum phase estimation.

The description herein refers to techniques employed by embodiments of the present invention as randomized Fourier estimation (RFE). RFE converts a time signal to a frequency spectrum, and the peak of this spectrum may further be used to yield an estimate of an unknown quantity θ that is encoded within in the time signal. The fact that the method is randomized is what facilitates a simple analysis of its performance in the presence of device error and allows error bounds to be computed to provide guarantees on the performance of the method under certain assumptions or conditions.

In order to analyze robustness, one must have a noise model to compare the performance of a noiseless model against. It is very challenging to accurately model the impact of device error on quantum algorithms. For the purposes of this disclosure, we will use an example of bounded adversarial noise as an example, but embodiments of the present invention should not be construed to be limited to this modeling of device error; a key advantage of the method disclosed is in its ability to be easily analyzed under many different noise models.

The effect of device error on a quantum algorithm's performance is mediated through the way that device error affects quantum measurement outcome probabilities. Rather than use a model for, say, gate-level quantum circuit errors, embodiments of the present invention may use simple, general models for the deviation of outcome probabilities. The disclosure herein refers to these as algorithm error models.

Embodiments of the present invention may include other robust algorithms for amplitude estimation, ground state energy estimation, etc. That is, by rewriting the input ansatz as a linear combination of eigenvalues, the Fourier spectrum generated by embodiments of the present invention corresponds to a time signal with multiple peaks which can be detected by RFE by choosing the maximum phase in specified intervals.

### Randomized Fourier Estimation

Consider the estimation of the phase angle θ, defined from U|ψ [symbol] =e^{iθ|ψ} [symbol] , where |ψ [symbol] is an eigenstate of U. Assumed is the ability to prepare the state |ψ [symbol] and the ability to apply the controlled unitary c-U:=|0 [symbol] [symbol] 0|⊗I+|1 [symbol] [symbol] 1|⊗U.

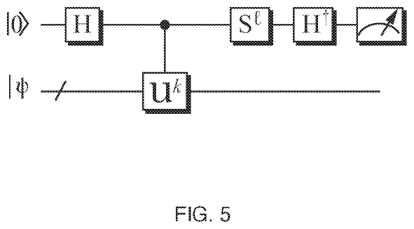

Embodiments of the present invention may include systems and methods which use data obtained from performing variants of a Hadamard test. An example of a Hadamard test is shown in FIG. 5.

In the case that [symbol] =0, for Hadamard test of U^{k} a quantum computer may be used to give c=±1 outcomes with probability

$$P r ( c \vert k ) = \frac{1 + c cos ( k θ )}{2} ,$$

where Re( [symbol] ψ|U|ψ [symbol] )=cos (θ)=Π. We refer to this procedure as a real Hadamard test.

A phase gate S may be placed before the ancilla measurement (that is [symbol] =1), in which case the probability of s=±1 is

$$P r ( s \vert k ) = \frac{1 + s sin ( k θ )}{2} .$$

We refer to this procedure as an imaginary Hadamard test.

One strategy for estimating cos θ (and therefore θ) is to set k=1, make a number of Hadamard test measurements with [symbol] =0, and compute the sample mean of c. This approach is often called the prepare-and-measure strategy.

We now describe examples of randomized Fourier estimation that may be implemented by embodiments of the present invention. Using Hadamard tests with k≥1, more information is gained about θ per measurement compared to the k=1 case. In contrast to the prepare-and-measure strategy, by using Hadamard test measurements with a large k, the above likelihoods will be highly sensitive to the value of θ. This sensitivity is leveraged to outperform the prepare-and-measure strategy.

Let k be a time variable. The biases in the probabilities of the real and imaginary Hadamard tests then encode oscillating time signals are given by cos kθ=Pr(c=1|k)−Pr(c=−1|k) and sin kθ=Pr(s=1|k)−Pr (s=−1|k). These are the expected values of c and s. By defining these values to be the real and imaginary parts of a complex time signal g(k), it follows that g(k)=cos kθ+i sin kθ=e^{ikθ}.

For fixed k, a time signal can be created by taking a plurality of pairs of real Hadamard test samples c andimaginary Hadamard test samples s, and forming them into a random variable whose expected value is the time signal at times k: [symbol] (c+is)=e^{ikθ}=g(k). The time signal can then be used to recover an estimate of the frequency θ; the accuracy of the estimate will depend on the number of test samples used to generate the time signal.

To produce a frequency spectrum, one may calculate the discrete Fourier transform (DFT) of the time signal. In the infinite-sample limit, when the time signal is g(k)=e^{ikθ}, the DFT will peak around a value corresponding to θ (due to the finite time window, there will be “leakage” effects which create additional smaller false peaks. When using a finite, but sufficiently large, number of samples the DFT of the time signal will still peak around the true peak.

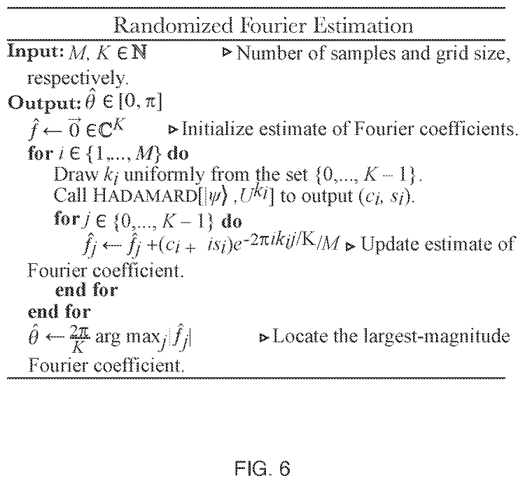

The time signal has K different times. Therefore, getting a constant-accuracy estimate of the time signal requires Ω(K) samples. An average sample takes time Ω(K), leading to a total runtime of Ω(K²). However, an accurate estimate of the time signal is not needed in order to get an accurate estimate of the location of the true peak in the Fourier domain. With Ω(log K) samples, the peak can be estimated to within 0 (¹/ₖ) accuracy with high probability. The total (expected) runtime is then 0 (K log K). A pseudocode description of randomized Fourier estimation is given in FIG. 6.

Embodiments of the method described above may achieve this performance in any of a variety of ways, such as the following. One benefit of embodiments of the method is that, with very few samples, the peak of the discrete Fourier transform can be detected.

From each real-imaginary Hadamard test sample pair, an unbiased estimate of the discrete Fourier transform may be constructed. This is achieved with a randomization over the choice of k. Drawing k from the uniform distribution over these values, the jth discrete Fourier coefficient estimate becomes: \hat{f}ⱼ=(c+is)e^{-2πjk/K} where j∈{0, . . . , K−1}. The expected value of this random variable is the discrete Fourier transform of the time signal g(k).

Define fⱼ:= [symbol] \hat{f}ⱼ. Viewed as a continuous function in j, the magnitude of fⱼ peaks at j=^{Kθ}/_{2π}. The method may average M independent Fourier coefficient estimates and then locate the frequency j for which the magnitude of the estimated coefficient is largest. The frequency estimate j corresponds to the estimate of θ via \hat{θ}=^{2πj}/_{K}.

The description here refers to j as frequencies as they index the frequency dimension, while k indexes the time dimension.

The granularity of the estimates is governed by K; the two frequencies closest to θ will be off by no more than ^{2π}/_{K} Choosing K=┌^{2π}/_{∈}┐ then ensures that outputting either of these adjacent frequencies gives |\hat{θ}−θ|≤∈. The frequency closest to θ (or frequencies closest, in the case they are equidistant from θ) will be off by no more than ^{π}/_{K}. This close frequency will have a large expected Fourier coefficient, while non-adjacent frequencies will have small expected Fourier coefficients.

The method succeeds when either close frequency is the output estimate.

The final step in estimating the phase angle θ from the frequency spectrum is to assess the likelihood of the close frequency being chosen. Loosely, the Hoeffding bound ensures that a mean over M samples will deviate by O(1) with no more than O(e^{-M}) chance. Combining this with a union bound gives that the likelihood that any of K such sample means deviates by more than O(1) is no more than O(Ke^{-M}). Therefore, by setting

$$K = 0 ( \frac{1}{ϵ} ) , M = O ( log \frac{1}{δ ε} ) \$$$

samples will suffice to ensure that no non-adjacent frequency is chosen with greater than 1-δ chance.

### Robustness of Randomized Fourier Estimation

We now present a “worst-case” example of a noise model under the condition that the noise is bounded. This example demonstrates the robustness of the disclosed method to noise. Embodiments of the disclosed method, therefore, may use the error bounds generated in this example to bound the error of an estimated phase angle.

The bounded-noise model imagines an “adversary” who may choose any deviation of the Hadamard test probabilities as long as they are within some limit. We show that there are performance guarantees as long as this limit is under the bound.

The bounded adversarial noise model assumes the following: once the parameters of the algorithm have been set (e.g. number of samples M, number of discrete points K, and the true value of the parameter θ), an adversary is able to set η_{1,k} and η_{2,k} to any value in the interval $ [−η̅,η̅]. The performance of any algorithm will be dependent on η̅. For this analysis, we assume

$$η < \frac{2 \sqrt{2}}{9 π} .$$

These assumptions allow for a more general demonstration of robustness; in a more realistic noise setting, noise tends not to act adversarially, but randomly.

The method succeeds if

$$K = ⌈ \frac{2 π}{ϵ} ⌉ > 4$$

and all estimated coefficients are within

$$\frac{4}{9 π}$$

or “in spec” or their expected value. Under the bounded adversarial noise model with bound η̅, the method will have all coefficients in spec with likelihood at least

$$1 - 4 K exp ( - \frac{2 {M ( 1 - \frac{9 π η}{2 \sqrt{2}} )}^{2}}{81 {π}^{2}} ) .$$

To ensure that this likelihood is greater than 1-δ, embodiments of the present invention may thus bound an error estimate of the phase angle by generating a time signal where

$$M \geq ⌈ \frac{81 {π}^{2}}{2} {( 1 - \frac{9 π}{2 \sqrt{2}} η )}^{- 2} ln \frac{8 π}{δϵ} ⌉ and K \geq ⌈ \frac{2 π}{ϵ} ⌉ .$$

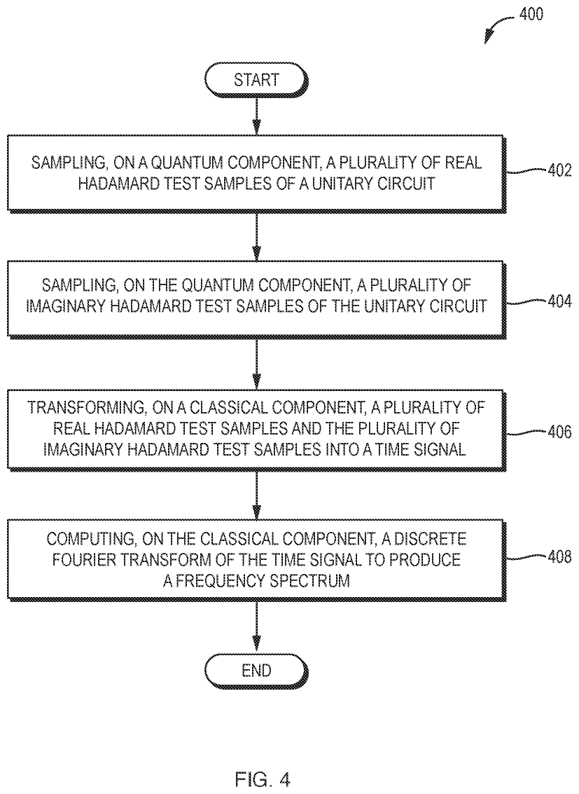

Referring to FIG. 4, a flowchart is shown of a method 400 performed by one embodiment of the present invention for converting a time signal into a frequency spectrum. The method 400 may, for example, be performed by or in cooperation with a hybrid quantum-classical computer having a quantum component (which may, for example, be a quantum computer) and a classical component. The method 400 may include: sampling, on the quantum component, a plurality of real Hadamard test samples of a unitary circuit (FIG. 4, operation 402); sampling, on the quantum component, a plurality of imaginary Hadamard test samples of the unitary circuit (FIG. 4, operation 404); transforming, on the classical component, the plurality of real Hadamard test samples and the plurality of imaginary Hadamard test samples into a time signal (FIG. 4, operation 406); and computing, on the classical component, a discrete Fourier transform of the time signal to produce a frequency spectrum (FIG. 4, operation 408).

The method may further include encoding, on the quantum component, a unitary matrix into the unitary circuit. The method may further include estimating, on the classical component, a phase angle from the frequency spectrum.

Estimating the phase angle may include identifying a largest-magnitude Fourier coefficient. The method may further include computing, on the classical component, an error estimate of the phase angle.

Sampling the plurality of real Hadamard test samples on the quantum component may include generating a set of noisy real test samples. Sampling the plurality of real Hadamard test samples on the quantum component may further include bounding an error of the set of noisy real test samples.

Sampling the plurality of imaginary Hadamard test samples on the quantum component may include generating a set of noisy imaginary test samples. Sampling the plurality of imaginary Hadamard test samples on the quantum component may further include bounding an error of the set of noisy imaginary test samples.

One embodiment of the present invention includes a system for use with a hybrid quantum-classical computer to convert a time signal into a frequency spectrum. The system may include: a quantum component (which may be a quantum computer); and a classical component. The classical component may include at least one processor and at least one non-transitory computer-readable medium having computer program instructions stored thereon. The computer program instructions may be executable by the at least one processor to perform a method. The method may include: sampling, using the quantum component, a plurality of real Hadamard test samples of a unitary circuit; sampling, using the quantum component, a plurality of imaginary Hadamard test samples of the unitary circuit; transforming, using the classical component, the plurality of real Hadamard test samples and the plurality of imaginary Hadamard test samples into a time signal; and computing, using the classical component, a discrete Fourier transform of the time signal to produce a frequency spectrum.

The method may further include encoding, on the quantum component, a unitary matrix into the unitary circuit. The method may further include estimating, on the classical component, a phase angle from the frequency spectrum. Estimating the phase angle may include identifying a largest-magnitude Fourier coefficient. The method may further include computing, on the classical component, an error estimate of the phase angle.

Sampling the plurality of real Hadamard test samples on the quantum component may include generating a set of noisy real test samples. Sampling the plurality of real Hadamard test samples on the quantum component may further include bounding an error of the set of noisy real test samples.

Sampling the plurality of imaginary Hadamard test samples on the quantum component may include generating a set of noisy imaginary test samples. Sampling the plurality of imaginary Hadamard test samples on the quantum component may further include bounding an error of the set of noisy imaginary test samples.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Various physical embodiments of a quantum computer are suitable for use according to the present disclosure. In general, the fundamental data storage unit in quantum computing is the quantum bit, or qubit. The qubit is a quantum-computing analog of a classical digital computer system bit. A classical bit is considered to occupy, at any given point in time, one of two possible states corresponding to the binary digits (bits) 0 or 1. By contrast, a qubit is implemented in hardware by a physical medium with quantum-mechanical characteristics. Such a medium, which physically instantiates a qubit, may be referred to herein as a “physical instantiation of a qubit,” a “physical embodiment of a qubit,” a “medium embodying a qubit,” or similar terms, or simply as a “qubit,” for ease of explanation. It should be understood, therefore, that references herein to “qubits” within descriptions of embodiments of the present invention refer to physical media which embody qubits.

Each qubit has an infinite number of different potential quantum-mechanical states. When the state of a qubit is physically measured, the measurement produces one of two different basis states resolved from the state of the qubit. Thus, a single qubit can represent a one, a zero, or any quantum superposition of those two qubit states; a pair of qubits can be in any quantum superposition of 4 orthogonal basis states; and three qubits can be in any superposition of 8 orthogonal basis states. The function that defines the quantum-mechanical states of a qubit is known as its wavefunction. The wavefunction also specifies the probability distribution of outcomes for a given measurement. A qubit, which has a quantum state of dimension two (i.e., has two orthogonal basis states), may be generalized to a d-dimensional “qudit,” where d may be any integral value, such as 2, 3, 4, or higher. In the general case of a qudit, measurement of the qudit produces one of d different basis states resolved from the state of the qudit. Any reference herein to a qubit should be understood to refer more generally to an d-dimensional qudit with any value of d.

Although certain descriptions of qubits herein may describe such qubits in terms of their mathematical properties, each such qubit may be implemented in a physical medium in any of a variety of different ways. Examples of such physical media include superconducting material, trapped ions, photons, optical cavities, individual electrons trapped within quantum dots, point defects in solids (e.g., phosphorus donors in silicon or nitrogen-vacancy centers in diamond), molecules (e.g., alanine, vanadium complexes), or aggregations of any of the foregoing that exhibit qubit behavior, that is, comprising quantum states and transitions therebetween that can be controllably induced or detected.

For any given medium that implements a qubit, any of a variety of properties of that medium may be chosen to implement the qubit. For example, if electrons are chosen to implement qubits, then the x component of its spin degree of freedom may be chosen as the property of such electrons to represent the states of such qubits. Alternatively, the y component, or the z component of the spin degree of freedom may be chosen as the property of such electrons to represent the state of such qubits. This is merely a specific example of the general feature that for any physical medium that is chosen to implement qubits, there may be multiple physical degrees of freedom (e.g., the x, y, and z components in the electron spin example) that may be chosen to represent 0 and 1. For any particular degree of freedom, the physical medium may controllably be put in a state of superposition, and measurements may then be taken in the chosen degree of freedom to obtain readouts of qubit values.

Certain implementations of quantum computers, referred to as gate model quantum computers, comprise quantum gates. In contrast to classical gates, there is an infinite number of possible single-qubit quantum gates that change the state vector of a qubit. Changing the state of a qubit state vector typically is referred to as a single-qubit rotation, and may also be referred to herein as a state change or a single-qubit quantum-gate operation. A rotation, state change, or single-qubit quantum-gate operation may be represented mathematically by a unitary 2×2 matrix with complex elements. A rotation corresponds to a rotation of a qubit state within its Hilbert space, which may be conceptualized as a rotation of the Bloch sphere. (As is well-known to those having ordinary skill in the art, the Bloch sphere is a geometrical representation of the space of pure states of a qubit.) Multi-qubit gates alter the quantum state of a set of qubits. For example, two-qubit gates rotate the state of two qubits as a rotation in the four-dimensional Hilbert space of the two qubits. (As is well-known to those having ordinary skill in the art, a Hilbert space is an abstract vector space possessing the structure of an inner product that allows length and angle to be measured. Furthermore, Hilbert spaces are complete: there are enough limits in the space to allow the techniques of calculus to be used.)

A quantum circuit may be specified as a sequence of quantum gates. As described in more detail below, the term “quantum gate,” as used herein, refers to the application of a gate control signal (defined below) to one or more qubits to cause those qubits to undergo certain physical transformations and thereby to implement a logical gate operation. To conceptualize a quantum circuit, the matrices corresponding to the component quantum gates may be multiplied together in the order specified by the gate sequence to produce a 2ⁿ×2ⁿ complex matrix representing the same overall state change on n qubits. A quantum circuit may thus be expressed as a single resultant operator. However, designing a quantum circuit in terms of constituent gates allows the design to conform to a standard set of gates, and thus enable greater ease of deployment. A quantum circuit thus corresponds to a design for actions taken upon the physical components of a quantum computer.

A given variational quantum circuit may be parameterized in a suitable device-specific manner. More generally, the quantum gates making up a quantum circuit may have an associated plurality of tuning parameters. For example, in embodiments based on optical switching, tuning parameters may correspond to the angles of individual optical elements.

In certain embodiments of quantum circuits, the quantum circuit includes both one or more gates and one or more measurement operations. Quantum computers implemented using such quantum circuits are referred to herein as implementing “measurement feedback.” For example, a quantum computer implementing measurement feedback may execute the gates in a quantum circuit and then measure only a subset (i.e., fewer than all) of the qubits in the quantum computer, and then decide which gate(s) to execute next based on the outcome(s) of the measurement(s). In particular, the measurement(s) may indicate a degree of error in the gate operation(s), and the quantum computer may decide which gate(s) to execute next based on the degree of error. The quantum computer may then execute the gate(s) indicated by the decision. This process of executing gates, measuring a subset of the qubits, and then deciding which gate(s) to execute next may be repeated any number of times. Measurement feedback may be useful for performing quantum error correction, but is not limited to use in performing quantum error correction. For every quantum circuit, there is an error-corrected implementation of the circuit with or without measurement feedback.

Some embodiments described herein generate, measure, or utilize quantum states that approximate a target quantum state (e.g., a ground state of a Hamiltonian). As will be appreciated by those trained in the art, there are many ways to quantify how well a first quantum state “approximates” a second quantum state. In the following description, any concept or definition of approximation known in the art may be used without departing from the scope hereof. For example, when the first and second quantum states are represented as first and second vectors, respectively, the first quantum state approximates the second quantum state when an inner product between the first and second vectors (called the “fidelity” between the two quantum states) is greater than a predefined amount (typically labeled E). In this example, the fidelity quantifies how “close” or “similar” the first and second quantum states are to each other. The fidelity represents a probability that a measurement of the first quantum state will give the same result as if the measurement were performed on the second quantum state. Proximity between quantum states can also be quantified with a distance measure, such as a Euclidean norm, a Hamming distance, or another type of norm known in the art. Proximity between quantum states can also be defined in computational terms. For example, the first quantum state approximates the second quantum state when a polynomial time-sampling of the first quantum state gives some desired information or property that it shares with the second quantum state.

Not all quantum computers are gate model quantum computers. Embodiments of the present invention are not limited to being implemented using gate model quantum computers. As an alternative example, embodiments of the present invention may be implemented, in whole or in part, using a quantum computer that is implemented using a quantum annealing architecture, which is an alternative to the gate model quantum computing architecture. More specifically, quantum annealing(QA) is a metaheuristic for finding the global minimum of a given objective function over a given set of candidate solutions (candidate states), by a process using quantum fluctuations.

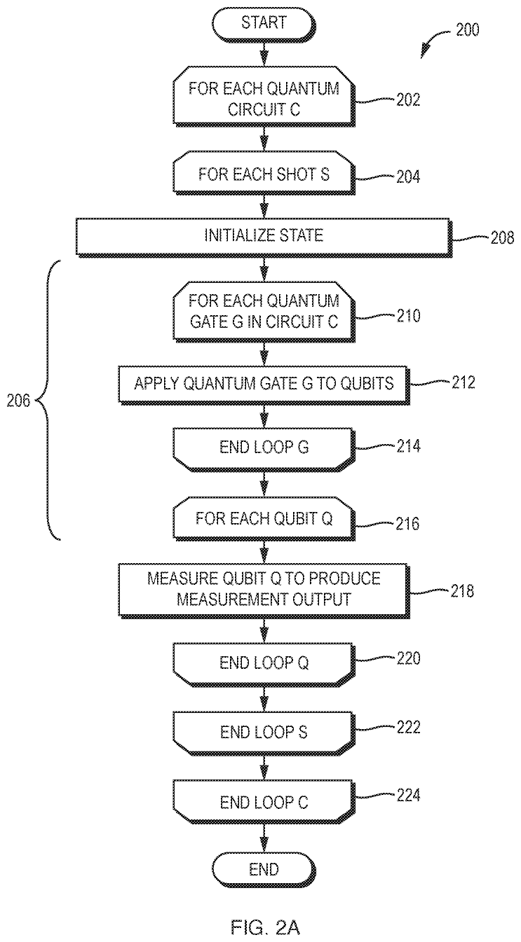

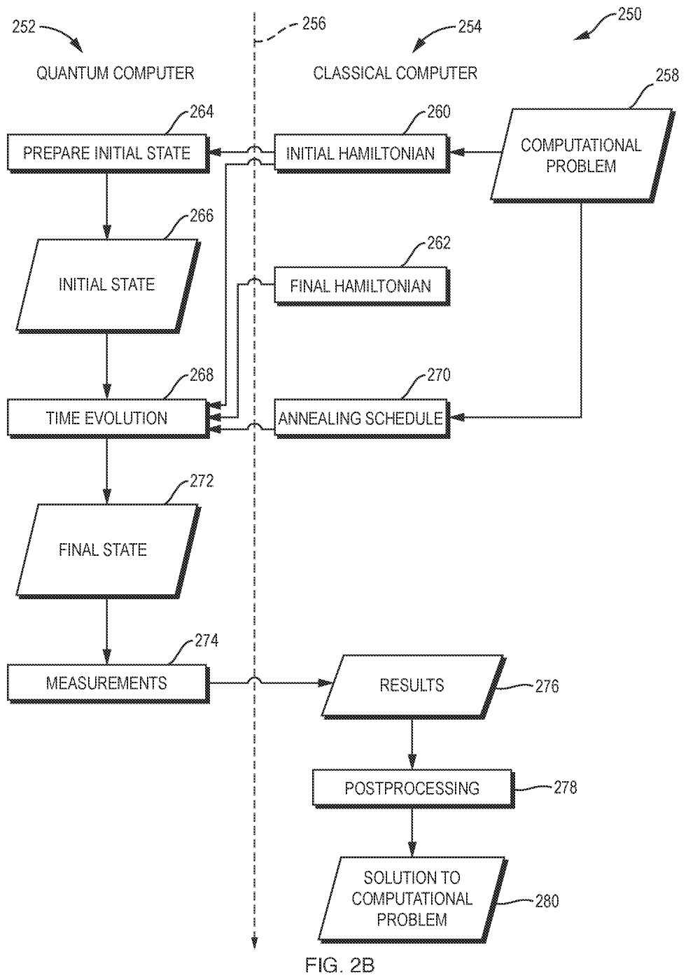

FIG. 2B shows a diagram illustrating operations typically performed by a computer system 250 which implements quantum annealing. The system 250 includes both a quantum computer 252 and a classical computer 254. Operations shown on the left of the dashed vertical line 256 typically are performed by the quantum computer 252, while operations shown on the right of the dashed vertical line 256 typically are performed by the classical computer 254.

Quantum annealing starts with the classical computer 254 generating an initial Hamiltonian 260 and a final Hamiltonian 262 based on a computational problem 258 to be solved, and providing the initial Hamiltonian 260, the final Hamiltonian 262 and an annealing schedule 270 as input to the quantum computer 252. The quantum computer 252 prepares a well-known initial state 266 (FIG. 2B, operation 264), such as a quantum-mechanical superposition of all possible states (candidate states) with equal weights, based on the initial Hamiltonian 260. The classical computer 254 provides the initial Hamiltonian 260, a final Hamiltonian 262, and an annealing schedule 270 to the quantum computer 252. The quantum computer 252 starts in the initial state 266, and evolves its state according to the annealing schedule 270 following the time-dependent Schrödinger equation, a natural quantum-mechanical evolution of physical systems (FIG. 2B, operation 268). More specifically, the state of the quantum computer 252 undergoes time evolution under a time-dependent Hamiltonian, which starts from the initial Hamiltonian 260 and terminates at the final Hamiltonian 262. If the rate of change of the system Hamiltonian is slow enough, the system stays close to the ground state of the instantaneous Hamiltonian. If the rate of change of the system Hamiltonian is accelerated, the system may leave the ground state temporarily but produce a higher likelihood of concluding in the ground state of the final problem Hamiltonian, i.e., diabatic quantum computation. At the end of the time evolution, the set of qubits on the quantum annealer is in a final state 272, which is expected to be close to the ground state of the classical Ising model that corresponds to the solution to the original computational problem 258. An experimental demonstration of the success of quantum annealing for random magnets was reported immediately after the initial theoretical proposal.

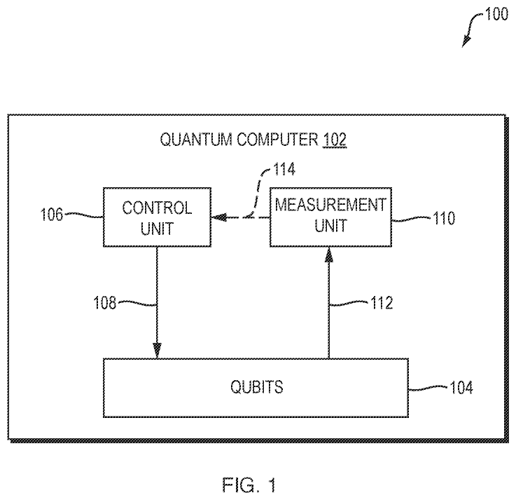

The final state 272 of the quantum computer 252 is measured, thereby producing results 276 (i.e., measurements) (FIG. 2B, operation 274). The measurement operation 274 may be performed, for example, in any of the ways disclosed herein, such as in any of the ways disclosed herein in connection with the measurement unit 110 in FIG. 1. The classical computer 254 performs postprocessing on the measurement results 276 to produce output 280 representing a solution to the original computational problem 258 (FIG. 2B, operation 278).

As yet another alternative example, embodiments of the present invention may be implemented, in whole or in part, using a quantum computer that is implemented using a one-way quantum computing architecture, also referred to as a measurement-based quantum computing architecture, which is another alternative to the gate model quantum computing architecture. More specifically, the one-way or measurement based quantum computer (MBQC) is a method of quantum computing that first prepares an entangled resource state, usually a cluster state or graph state, then performs single qubit measurements on it. It is “one-way” because the resource state is destroyed by the measurements.

The outcome of each individual measurement is random, but they are related in such a way that the computation always succeeds. In general the choices of basis for later measurements need to depend on the results of earlier measurements, and hence the measurements cannot all be performed at the same time.

Any of the functions disclosed herein may be implemented using means for performing those functions. Such means include, but are not limited to, any of the components disclosed herein, such as the computer-related components described below.

Referring to FIG. 1, a diagram is shown of a system 100 implemented according to one embodiment of the present invention. Referring to FIG. 2A, a flowchart is shown of a method 200 performed by the system 100 of FIG. 1 according to one embodiment of the present invention. The system 100 includes a quantum computer 102. The quantum computer 102 includes a plurality of qubits 104, which may be implemented in any of the ways disclosed herein. There may be any number of qubits 104 in the quantum computer 102. For example, the qubits 104 may include or consist of no more than 2 qubits, no more than 4 qubits, no more than 8 qubits, no more than 16 qubits, no more than 32 qubits, no more than 64 qubits, no more than 128 qubits, no more than 256 qubits, no more than 512 qubits, no more than 1024 qubits, no more than 2048 qubits, no more than 4096 qubits, or no more than 8192 qubits. These are merely examples, in practice there may be any number of qubits 104 in the quantum computer 102.

There may be any number of gates in a quantum circuit. However, in some embodiments the number of gates may be at least proportional to the number of qubits 104 in the quantum computer 102. In some embodiments the gate depth may be no greater than the number of qubits 104 in the quantum computer 102, or no greater than some linear multiple of the number of qubits 104 in the quantum computer 102 (e.g., 2, 3, 4, 5, 6, or 7).

The qubits 104 may be interconnected in any graph pattern. For example, they be connected in a linear chain, a two-dimensional grid, an all-to-all connection, any combination thereof, or any subgraph of any of the preceding.

As will become clear from the description below, although element 102 is referred to herein as a “quantum computer,” this does not imply that all components of the quantum computer 102 leverage quantum phenomena. One or more components of the quantum computer 102 may, for example, be classical (i.e., non-quantum components) components which do not leverage quantum phenomena.

The quantum computer 102 includes a control unit 106, which may include any of a variety of circuitry and/or other machinery for performing the functions disclosed herein. The control unit 106 may, for example, consist entirely of classical components. The control unit 106 generates and provides as output one or more control signals 108 to the qubits 104. The control signals 108 may take any of a variety of forms, such as any kind of electromagnetic signals, such as electrical signals, magnetic signals, optical signals (e.g., laser pulses), or any combination thereof.

For example:
In embodiments in which some or all of the qubits 104 are implemented as photons (also referred to as a “quantum optical” implementation) that travel along waveguides, the control unit 106 may be a beam splitter (e.g., a heater or a mirror), the control signals 108 may be signals that control the heater or the rotation of the mirror, the measurement unit 110 may be a photodetector, and the measurement signals 112 may be photons.
In embodiments in which some or all of the qubits 104 are implemented as charge type qubits (e.g., transmon, X-mon, G-mon) or flux-type qubits (e.g., flux qubits, capacitively shunted flux qubits) (also referred to as a “circuit quantum electrodynamic” (circuit QED) implementation), the control unit 106 may be a bus resonator activated by a drive, the control signals 108 may be cavity modes, the measurement unit 110 may be a second resonator (e.g., a low-Q resonator), and the measurement signals 112 may be voltages measured from the second resonator using dispersive readout techniques.
In embodiments in which some or all of the qubits 104 are implemented as superconducting circuits, the control unit 106 may be a circuit QED-assisted control unit or a direct capacitive coupling control unit or an inductive capacitive coupling control unit, the control signals 108 may be cavity modes, the measurement unit 110 may be a second resonator (e.g., a low-Q resonator), and the measurement signals 112 may be voltages measured from the second resonator using dispersive readout techniques.
In embodiments in which some or all of the qubits 104 are implemented as trapped ions (e.g., electronic states of, e.g., magnesium ions), the control unit 106 may be a laser, the control signals 108 may be laser pulses, the measurement unit 110 may be a laser and either a CCD or a photodetector (e.g., a photomultiplier tube), and the measurement signals 112 may be photons.
In embodiments in which some or all of the qubits 104 are implemented using nuclear magnetic resonance (NMR) (in which case the qubits may be molecules, e.g., in liquid or solid form), the control unit 106 may be a radio frequency (RF) antenna, the control signals 108 may be RF fields emitted by the RF antenna, the measurement unit 110 may be another RF antenna, and the measurement signals 112 may be RF fields measured by the second RF antenna.
In embodiments in which some or all of the qubits 104 are implemented as nitrogen-vacancy centers (NV centers), the control unit 106 may, for example, be a laser, a microwave antenna, or a coil, the control signals 108 may be visible light, a microwave signal, or a constant electromagnetic field, the measurement unit 110 may be a photodetector, and the measurement signals 112 may be photons.
In embodiments in which some or all of the qubits 104 are implemented as two-dimensional quasiparticles called “anyons” (also referred to as a “topological quantum computer” implementation), the control unit 106 may be nanowires, the control signals 108 may be local electrical fields or microwave pulses, the measurement unit 110 may be superconducting circuits, and the measurement signals 112 may be voltages.
In embodiments in which some or all of the qubits 104 are implemented as semiconducting material (e.g., nanowires), the control unit 106 may be microfabricated gates, the control signals 108 may be RF or microwave signals, the measurement unit 110 may be microfabricated gates, and the measurement signals 112 may be RF or microwave signals.

Although not shown explicitly in FIG. 1 and not required, the measurement unit 110 may provide one or more feedback signals 114 to the control unit 106 based on the measurement signals 112. For example, quantum computers referred to as “one-way quantum computers” or “measurement-based quantum computers” utilize such feedback signals 114 from the measurement unit 110 to the control unit 106. Such feedback signals 114 are also necessary for the operation of fault-tolerant quantum computing and error correction.

The control signals 108 may, for example, include one or more state preparation signals which, when received by the qubits 104, cause some or all of the qubits 104 to change their states. Such state preparation signals constitute a quantum circuit also referred to as an “ansatz circuit.” The resulting state of the qubits 104 is referred to herein as an “initial state” or an “ansatz state.” The process of outputting the state preparation signal(s) to cause the qubits 104 to be in their initial state is referred to herein as “state preparation” (FIG. 2A, section 206). A special case of state preparation is “initialization,” also referred to as a “reset operation,” in which the initial state is one in which some or all of the qubits 104 are in the “zero” state i.e. the default single-qubit state. More generally, state preparation may involve using the state preparation signals to cause some or all of the qubits 104 to be in any distribution of desired states. In some embodiments, the control unit 106 may first perform initialization on the qubits 104 and then perform preparation on the qubits 104, by first outputting a first set of state preparation signals to initialize the qubits 104, and by then outputting a second set of state preparation signals to put the qubits 104 partially or entirely into non-zero states.

Another example of control signals 108 that may be output by the control unit 106 and received by the qubits 104 are gate control signals. The control unit 106 may output such gate control signals, thereby applying one or more gates to the qubits 104. Applying a gate to one or more qubits causes the set of qubits to undergo a physical state change which embodies a corresponding logical gate operation (e.g., single-qubit rotation, two-qubit entangling gate or multi-qubit operation) specified by the received gate control signal. As this implies, in response to receiving the gate control signals, the qubits 104 undergo physical transformations which cause the qubits 104 to change state in such a way that the states of the qubits 104, when measured (see below), represent the results of performing logical gate operations specified by the gate control signals. The term “quantum gate,” as used herein, refers to the application of a gate control signal to one or more qubits to cause those qubits to undergo the physical transformations described above and thereby to implement a logical gate operation.

It should be understood that the dividing line between state preparation (and the corresponding state preparation signals) and the application of gates (and the corresponding gate control signals) may be chosen arbitrarily. For example, some or all the components and operations that are illustrated in FIGS. 1 and 2A-2B as elements of “state preparation” may instead be characterized as elements of gate application. Conversely, for example, some or all of the components and operations that are illustrated in FIGS. 1 and 2A-2B as elements of “gate application” may instead be characterized as elements of state preparation. As one particular example, the system and method of FIGS. 1 and 2A-2B may be characterized as solely performing state preparation followed by measurement, without any gate application, where the elements that are described herein as being part of gate application are instead considered to be part of state preparation. Conversely, for example, the system and method of FIGS. 1 and 2A-2B may be characterized as solely performing gate application followed by measurement, without any state preparation, and where the elements that are described herein as being part of state preparation are instead considered to be part of gate application.

The quantum computer 102 also includes a measurement unit 110, which performs one or more measurement operations on the qubits 104 to read out measurement signals 112 (also referred to herein as “measurement results”) from the qubits 104, where the measurement results 112 are signals representing the states of some or all of the qubits 104. In practice, the control unit 106 and the measurement unit 110 may be entirely distinct from each other, or contain some components in common with each other, or be implemented using a single unit (i.e., a single unit may implement both the control unit 106 and the measurement unit 110). For example, a laser unit may be used both to generate the control signals 108 and to provide stimulus (e.g., one or more laser beams) to the qubits 104 to cause the measurement signals 112 to be generated.

In general, the quantum computer 102 may perform various operations described above any number of times. For example, the control unit 106 may generate one or more control signals 108, thereby causing the qubits 104 to perform one or more quantum gate operations. The measurement unit 110 may then perform one or more measurement operations on the qubits 104 to read out a set of one or more measurement signals 112. The measurement unit 110 may repeat such measurement operations on the qubits 104 before the control unit 106 generates additional control signals 108, thereby causing the measurement unit 110 to read out additional measurement signals 112 resulting from the same gate operations that were performed before reading out the previous measurement signals 112. The measurement unit 110 may repeat this process any number of times to generate any number of measurement signals 112 corresponding to the same gate operations. The quantum computer 102 may then aggregate such multiple measurements of the same gate operations in any of a variety of ways.

After the measurement unit 110 has performed one or more measurement operations on the qubits 104 after they have performed one set of gate operations, the control unit 106 may generate one or more additional control signals 108, which may differ from the previous control signals 108, thereby causing the qubits 104 to perform one or more additional quantum gate operations, which may differ from the previous set of quantum gate operations. The process described above may then be repeated, with the measurement unit 110 performing one or more measurement operations on the qubits 104 in their new states (resulting from the most recently-performed gate operations).

In general, the system 100 may implement a plurality of quantum circuits as follows. For each quantum circuit C in the plurality of quantum circuits (FIG. 2A, operation 202), the system 100 performs a plurality of “shots” on the qubits 104. The meaning of a shot will become clear from the description that follows. For each shot S in the plurality of shots (FIG. 2A, operation 204), the system 100 prepares the state of the qubits 104 (FIG. 2A, section 206). More specifically, for each quantum gate G in quantum circuit C (FIG. 2A, operation 210), the system 100 applies quantum gate G to the qubits 104 (FIG. 2A, operations 212 and 214).

Then, for each of the qubits Q 104 (FIG. 2A, operation 216), the system 100 measures the qubit Q to produce measurement output representing a current state of qubit Q(FIG. 2A, operations 218 and 220).

The operations described above are repeated for each shot S (FIG. 2A, operation 222), and circuit C (FIG. 2A, operation 224). As the description above implies, a single “shot” involves preparing the state of the qubits 104 and applying all of the quantum gates in a circuit to the qubits 104 and then measuring the states of the qubits 104; and the system 100 may perform multiple shots for one or more circuits.

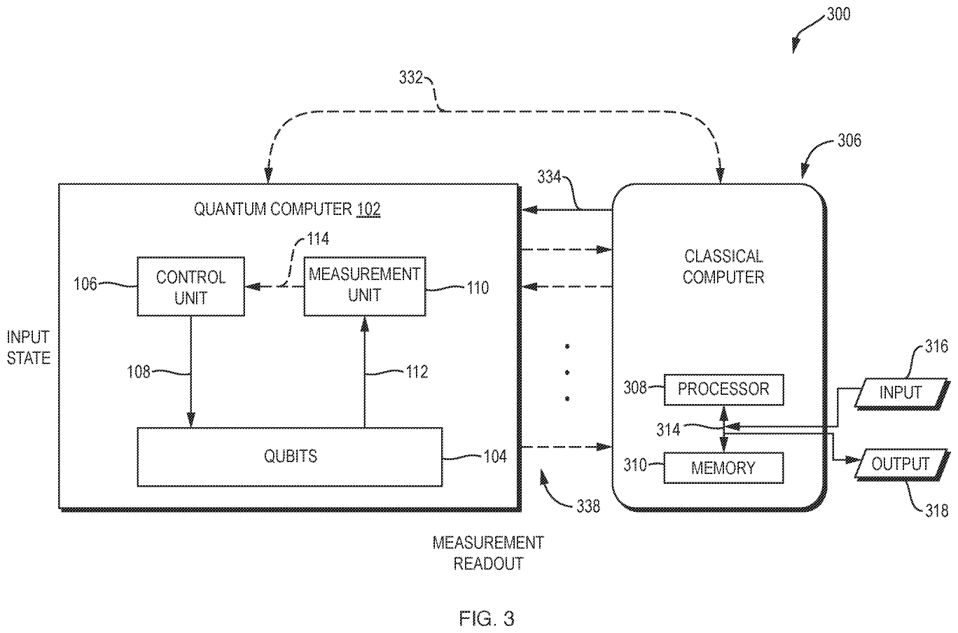

Referring to FIG. 3, a diagram is shown of a hybrid quantum classical (HQC) computer 300 implemented according to one embodiment of the present invention. The HQC 300 includes a quantum computer component 102 (which may, for example, be implemented in the manner shown and described in connection with FIG. 1) and a classical computer component 306. The classical computer component may be a machine implemented according to the general computing model established by John Von Neumann, in which programs are written in the form of ordered lists of instructions and stored within a classical (e.g., digital) memory 310 and executed by a classical (e.g., digital) processor 308 of the classical computer. The memory 310 is classical in the sense that it stores data in a storage medium in the form of bits, which have a single definite binary state at any point in time. The bits stored in the memory 310 may, for example, represent a computer program. The classical computer component 304 typically includes a bus 314. The processor 308 may read bits from and write bits to the memory 310 over the bus 314. For example, the processor 308 may read instructions from the computer program in the memory 310, and may optionally receive input data 316 from a source external to the computer 302, such as from a user input device such as a mouse, keyboard, or any other input device. The processor 308 may use instructions that have been read from the memory 310 to perform computations on data read from the memory 310 and/or the input 316, and generate output from those instructions. The processor 308 may store that output back into the memory 310 and/or provide the output externally as output data 318 via an output device, such as a monitor, speaker, or network device.

The quantum computer component 102 may include a plurality of qubits 104, as described above in connection with FIG. 1. A single qubit may represent a one, a zero, or any quantum superposition of those two qubit states. The classical computer component 304 may provide classical state preparation signals 332 to the quantum computer 102, in response to which the quantum computer 102 may prepare the states of the qubits 104 in any of the ways disclosed herein, such as in any of the ways disclosed in connection with FIGS. 1 and 2A-2B.

Once the qubits 104 have been prepared, the classical processor 308 may provide classical control signals 334 to the quantum computer 102, in response to which the quantum computer 102 may apply the gate operations specified by the control signals 332 to the qubits 104, as a result of which the qubits 104 arrive at a final state. The measurement unit 110 in the quantum computer 102 (which may be implemented as described above in connection with FIGS. 1 and 2A-2B) may measure the states of the qubits 104 and produce measurement output 338 representing the collapse of the states of the qubits 104 into one of their eigenstates. As a result, the measurement output 338 includes or consists of bits and therefore represents a classical state. The quantum computer 102 provides the measurement output 338 to the classical processor 308. The classical processor 308 may store data representing the measurement output 338 and/or data derived therefrom in the classical memory 310.

The steps described above may be repeated any number of times, with what is described above as the final state of the qubits 104 serving as the initial state of the next iteration. In this way, the classical computer 304 and the quantum computer 102 may cooperate as co-processors to perform joint computations as a single computer system.

Although certain functions may be described herein as being performed by a classical computer and other functions may be described herein as being performed by a quantum computer, these are merely examples and do not constitute limitations of the present invention. A subset of the functions which are disclosed herein as being performed by a quantum computer may instead be performed by a classical computer. For example, a classical computer may execute functionality for emulating a quantum computer and provide a subset of the functionality described herein, albeit with functionality limited by the exponential scaling of the simulation. Functions which are disclosed herein as being performed by a classical computer may instead be performed by a quantum computer.

The techniques described above may be implemented, for example, in hardware, in one or more computer programs tangibly stored on one or more computer-readable media, firmware, or any combination thereof, such as solely on a quantum computer, solely on a classical computer, or on a hybrid quantum classical (HQC) computer. The techniques disclosed herein may, for example, be implemented solely on a classical computer, in which the classical computer emulates the quantum computer functions disclosed herein.

Any reference herein to the state |0 [symbol] may alternatively refer to the state |1 [symbol] , and vice versa. In other words, any role described herein for the states |0 [symbol] and |1 [symbol] may be reversed within embodiments of the present invention. More generally, any computational basis state disclosed herein may be replaced with any suitable reference state within embodiments of the present invention.

The techniques described above may be implemented in one or more computer programs executing on (or executable by) a programmable computer (such as a classical computer, a quantum computer, or an HQC) including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention implement quantum algorithms which are robust to some degree of error on error-prone quantum computers. Such techniques are inherently rooted in quantum computing technology and cannot be performed mentally or manually.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

In embodiments in which a classical computing component executes a computer program providing any subset of the functionality within the scope of the claims below, the computer program may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor, which may be either a classical processor or a quantum processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A classical computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium (such as a classical computer-readable medium, a quantum computer-readable medium, or an HQC computer-readable medium). Embodiments of the invention may store such data in such data structure(s) and read such data from such data structure(s).

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

What is claimed is:

1. A method for converting, on a hybrid quantum-classical computer having a quantum component and a classical component, a time signal into a frequency spectrum, the method comprising:
sampling, on the quantum component, a plurality of real Hadamard test samples of a unitary circuit;
sampling, on the quantum component, a plurality of imaginary Hadamard test samples of the unitary circuit;
transforming, on the classical component, the plurality of real Hadamard test samples and the plurality of imaginary Hadamard test samples into a time signal; and
computing, on the classical component, a discrete Fourier transform of the time signal to produce a frequency spectrum.

2. The method of claim 1, further comprising encoding, on the quantum component, a unitary matrix into the unitary circuit.

3. The method of claim 1, further comprising estimating, on the classical component, a phase angle from the frequency spectrum.

4. The method of claim 3, wherein estimating the phase angle comprises identifying a largest-magnitude Fourier coefficient.

5. The method of claim 3, further comprising computing, on the classical component, an error estimate of the phase angle.

6. The method of claim 1, wherein sampling the plurality of real Hadamard test samples on the quantum component comprises generating a set of noisy real test samples.

7. The method of claim 6, wherein sampling the plurality of real Hadamard test samples on the quantum component further comprises bounding an error of the set of noisy real test samples.

8. The method of claim 1, wherein sampling the plurality of imaginary Hadamard test samples on the quantum component comprises generating a set of noisy imaginary test samples.

9. The method of claim 8, wherein sampling the plurality of imaginary Hadamard test samples on the quantum component further comprises bounding an error of the set of noisy imaginary test samples.

10. A system for use with a hybrid quantum-classical computer to convert a time signal into a frequency spectrum, the system comprising:
a quantum component;
a classical component, the classical component comprising at least one processor and at least one non-transitory computer-readable medium having computer program instructions stored thereon, the computer program instructions being executable by the at least one processor to perform a method, the method comprising:
sampling, using the quantum component, a plurality of real Hadamard test samples of a unitary circuit;
sampling, using the quantum component, a plurality of imaginary Hadamard test samples of the unitary circuit;
transforming, using the classical component, the plurality of real Hadamard test samples and the plurality of imaginary Hadamard test samples into a time signal; and
computing, using the classical component, a discrete Fourier transform of the time signal to produce a frequency spectrum.

11. The system of claim 10, wherein the method further comprises encoding, on the quantum component, a unitary matrix into the unitary circuit.

12. The system of claim 10, wherein the method further comprises estimating, on the classical component, a phase angle from the frequency spectrum.

13. The system of claim 12, wherein estimating the phase angle comprises identifying a largest-magnitude Fourier coefficient.

14. The system of claim 12, wherein the method further comprises computing, on the classical component, an error estimate of the phase angle.

15. The system of claim 10, wherein sampling the plurality of real Hadamard test samples on the quantum component comprises generating a set of noisy real test samples.

16. The system of claim 15, wherein sampling the plurality of real Hadamard test samples on the quantum component further comprises bounding an error of the set of noisy real test samples.

17. The system of claim 10, wherein sampling the plurality of imaginary Hadamard test samples on the quantum component comprises generating a set of noisy imaginary test samples.

18. The system of claim 17, wherein sampling the plurality of imaginary Hadamard test samples on the quantum component further comprises bounding an error of the set of noisy imaginary test samples.
